(19) United States
(12) Patent Application Publication
(10) Pub. No.: US 2016/0294959 A1
(43) Pub. Date: Oct. 6, 2016

(54) LIFESTYLE SERVICE DESIGN SYSTEM AND METHOD

(71) Applicant: AJOU UNIVERSITY INDUSTRY-ACADEMIC COOPERATION FOUNDATION, Suwon-si, Gyeonggi-do (KR)

(72) Inventor: We Duke CHO, Seongnam-si (KR)

(73) Assignee: AJOU UNIVERSITY INDUSTRY-ACADEMIC COOPERATION FOUNDATION, Suwon-si, Gyeonggi-do (KR)

(21) Appl. No.: 14/392,268

(22) PCT Filed: Jun. 25, 2014
(86) PCT No.: PCT/KR2014/005619

§ 371 Date: Dec. 24, 2015

(30) Foreign Application Priority Data
Jun. 25, 2013 (KR) 10-2013-0072842

(51) Int. Cl. H04L 29/08; G06F 19/00

(52) U.S. Cl. CPC H04L 67/22; G06F 19/322

(57) ABSTRACT

The present invention relates to a technique of managing a lifestyle, and the present invention is directed to provide a system and a method for designing a lifestyle service which collects big data of personal lifelogs, collects analysis of personal activities through the collected lifelogs, and estimates possible user's behavior based on the collected analysis of personal activities to induce the user's behavior in a preferable direction which may improve quality of life according to the estimated user's behavior to manage the user's health.

### TECHNICAL FIELD

The present invention relates to a technique of managing a lifestyle, which collects big data of personal lifelogs, collects analysis of personal activities through the collected lifelogs, and estimates possible user's behavior based on the collected analysis of personal activities to induce the user's behavior in a desirable direction which may improve quality of life according to the estimated user's behavior and manage the user's health.

### BACKGROUND ART

In Korea, particularly, patients with lifestyle-related diseases are rapidly increased, and patients with similar metabolic diseases which are not simply explained only westernization of dietary life, aging, and an increase in obese people appears from infancy and adolescence. The lifestyle-related diseases are not resolved well by medical drug treatment and medical costs of national health insurance have steadily increased with development of chronic diseases. As the solution thereof, lifestyle medicine has been important, but is difficult to be applied due to problems such as difficulty of a traditional medial examination method, continuous treatment effect, systematic management of the patients, and substantial effects.

Currently, various IT products and care services (child protection and growth care, elderly protection care, spiritual healing care of the public, financial forecasting management in a rapidly changing economic situation, and the like) have fundamental limits in application and advancement because understanding, expression, and quantifying for “human” as the final user and a complicated characteristic thereof (social relationship, psychology, physiology, emotion, and the like) are not easy.

Particularly, consideration for elements that determine “I” represented by the lifestyle is insufficient, and there is difficulty in tools or methods to characteristically express the human beings with complicated and various characteristics.

As a method for overcoming the problems, various researches of using lifelog data have been conducted globally, but absence of innovative devices for collecting the lifelog and dilemma of semantic analysis of a vast amount of data are still not resolved.

As an example of a life care service technique in the related art, “a system of providing a life care service” in Korea Patent Publication No. 2012-0045459 was proposed. In the prior art, a life care service technique of collecting information as a life required to verify a health state of the user and analyzing lifelog information to provide life care information used for managing the lifestyle of the user was disclosed.

However, in the related art, in order to manage the lifestyle of the user by analyzing the lifelog information, first, a process of setting the lifestyle is required and rules corresponding to a specific situation need to be predetermined. In the prior art, the predetermined rules have individual differences, but are not considered and not properly changed depending on the time flow, and a detailed technique for a method of setting the rules is not mentioned. Further, in the prior art, when the lifelog is analyzed, human diversity is not considered.

Therefore, the present invention relates to a technique of managing a lifestyle, and a method of collecting big data of personal lifelogs, collecting analysis of personal activities through the collected lifelogs, and estimating possible user's behavior based on the collected analysis of personal activities to induce the user's behavior in a desirable direction which may improve quality of life according to the estimated user's behavior and manage the user's health is required

### DISCLOSURE

### Technical Problem

The present invention is directed to provide a system and a method for designing a lifestyle service.

In detail, the present invention relates to a technique of managing a lifestyle, and the present invention is directed to provide a system and a method for designing a lifestyle service which collects big data of personal lifelogs, collects analysis of personal activities through the collected lifelogs, and estimates possible user's behavior based on the collected analysis of personal activities to induce the user's behavior in a desirable direction which may improve quality of life according to the estimated user's behavior and manage the user's health.

### Technical Solution

One aspect of the present invention provides a system for designing a lifestyle service including: a lifelog collecting device collecting lifelogs; an experience data collecting device analyzing individual tendencies by using the collected lifelogs and collecting personalized experience data for each individual tendency; and a service design device estimating a possible user's behavior based on the experience data and current information of the user and designing a service according to the estimated user's behavior.

In this case, the lifelogs may include at least one of private data, public data, personal data, anonymous data, connected data, and sensor data.

In this case, the experience data collecting device may include lifestyle service service design system that collects analysis of individual activities by analyzing life patterns which are repeated more than a predetermined number of times in the collected lifelogs.

In this case, the service design device may motivate the user to avoid the estimated user's behavior by using the collected experience data and domain characteristics (SNS, card payment, shopping payment, location information, and the like) and design the service to induce the motivated user to avoid the estimated behavior.

Further, the service design device may analyze a surrounding environment of the user and design the service to induce the user to a change in the user's behavior through virtual experience by using the surrounding environment of the user.

Further, the service design device may design the service by analyzing a user's feature and a preferred channel according to the user's feedback to provide the designed service to the user according to the analyzed preferred channel.

Another aspect of the present invention provides a method for designing a lifestyle service including: collecting lifelogs; analyzing individual tendencies by using the collected lifelogs and collecting personalized experience data for each individual tendency; and estimating a possible user's behavior based on the experience data and current information of the user and designing a service according to the estimated user's behavior.

In this case, the lifelogs may include at least one of private data, public data, personal data, anonymous data, connected data, and sensor data.

In this case, in the collecting of the experience data, analysis of individual activities may be collected by analyzing life patterns which are repeated more than a predetermined number of times in the collected lifelogs.

The method may further include collecting tracking data by analyzing a movement path of the user and estimating the movement path of the user from the collected tracking data.

In this case, in the designing of the service, the user may be motivated to avoid the estimated user's behavior by using the collected experience data and domain characteristics (SNS, card payment, shopping payment, location information, and the like) and the service may be designed to induce the motivated user to avoid the estimated behavior.

Further, in the designing of the service, a surrounding environment of the user is analyzed and the service may be designed to induce the user to a change in the user's behavior through virtual experience by using the surrounding environment of the user.

Further, in the designing of the service, the service may be designed by analyzing a user's feature and a preferred channel according to the user's feedback to provide the designed service to the user according to the analyzed preferred channel.

### Advantageous Effects

The present invention relates to a technique of managing a lifestyle, which collects big data of personal lifelogs, collects analysis of personal activities through the collected lifelogs, and estimates possible user's behavior based on the collected analysis of personal activities to induce the user's behavior in a desirable direction which may improve quality of life according to the estimated user's behavior and manage the user's health.

### DESCRIPTION OF DRAWINGS

FIG. 1 is a diagram illustrating a configuration of an autonomous lifestyle care system according to an exemplary embodiment of the present invention.

FIG. 2 is a diagram illustrating a configuration of a reference modeling device for modeling a generalized lifestyle according to the exemplary embodiment of the present invention.

FIG. 3 is a diagram illustrating a configuration of a personalized modeling device for modeling a personalized lifestyle according to the exemplary embodiment of the present invention.

FIG. 4 is a flowchart illustrating a process of managing the lifestyle in the autonomous lifestyle care system according to the exemplary embodiment of the present invention.

FIG. 5 is a flowchart illustrating a process of generating a reference model in the reference modeling device according to the exemplary embodiment of the present invention.

FIG. 6 is a flowchart illustrating a process of generating a personalized lifestyle model in the personalized modeling device according to the exemplary embodiment of the present invention.

FIG. 7 is a diagram illustrating an example of the reference model generated according to the exemplary embodiment of the present invention.

FIG. 8 is a flowchart illustrating a method for designing a lifestyle service according to another exemplary embodiment of the present invention.

FIG. 9 is a diagram illustrating an example of a persuasion type design in a lifestyle service design according to yet another exemplary embodiment of the present invention.

FIG. 10 is a diagram illustrating an example for determining an implicit motive and inducing a behavior in the lifestyle service design according to yet another exemplary embodiment of the present invention.

FIG. 11 is a diagram illustrating a system for designing a lifestyle service according to still another exemplary embodiment of the present invention.

### BEST MODE OF THE INVENTION

One aspect of the present invention provides a system for designing a lifestyle service including: a lifelog collecting device collecting lifelogs; an experience data collecting device analyzing individual tendencies by using the collected lifelogs and collecting personalized experience data for each individual tendency; and a service design device estimating a possible user's behavior based on the experience data and current information of the user and designing a service according to the estimated user's behavior.

In this case, the lifelogs may include at least one of private data, public data, personal data, anonymous data, connected data, and sensor data.

In this case, the experience data collecting device may include lifestyle service service design system that collects analysis of individual activities by analyzing life patterns which are repeated more than a predetermined number of times in the collected lifelogs.

In this case, the service design device may motivate the user to avoid the estimated user's behavior by using the collected experience data and domain characteristics (SNS, card payment, shopping payment, location information, and the like) and design the service to induce the motivated user to avoid the estimated behavior.

Further, the service design device may analyze a surrounding environment of the user and design the service to induce the user to a change in the user's behavior through virtual experience by using the surrounding environment of the user.

Further, the service design device may design the service by analyzing a user's feature and a preferred channel according to the user's feedback to provide the designed service to the user according to the analyzed preferred channel.

Another aspect of the present invention provides a method for designing a lifestyle service including: collecting lifelogs; analyzing individual tendencies by using the collected lifelogs and collecting personalized experience data for each individual tendency; and estimating a possible user's behavior based on the experience data and current information of the user and designing a service according to the estimated user's behavior.

In this case, the lifelogs may include at least one of private data, public data, personal data, anonymous data, connected data, and sensor data.

In this case, in the collecting of the experience data, analysis of individual activities may be collected by analyzing life patterns which are repeated more than a predetermined number of times in the collected lifelogs.

The method may further include collecting tracking data by analyzing a movement path of the user and estimating the movement path of the user from the collected tracking data.

In this case, the in the designing of the service, the user may be motivated to avoid the estimated user's behavior by using the collected experience data and domain characteristics (SNS, card payment, shopping payment, location information, and the like) and the service may be designed to induce the motivated user to avoid the estimated behavior.

Further, in the designing of the service, a surrounding environment of the user is analyzed and the service may be designed to induce the user to a change in the user's behavior through virtual experience by using the surrounding environment of the user.

Further, in the designing of the service, the service may be designed by analyzing a user's feature and a preferred channel according to the user's feedback to provide the designed service to the user according to the analyzed preferred channel.

### Modes of the Invention

Other objects and features than the above-described object will be apparent from the description of exemplary embodiments with reference to the accompanying drawings.

Hereinafter, exemplary embodiments of the present invention will be described in detail with reference to the accompanying drawings. Further, in the following description, a detailed explanation of known related technologies may be omitted to avoid unnecessarily obscuring the subject matter of the present invention.

However, the present invention is not restricted or limited to the exemplary embodiments. Like reference numerals illustrated in the respective drawings designate like members.

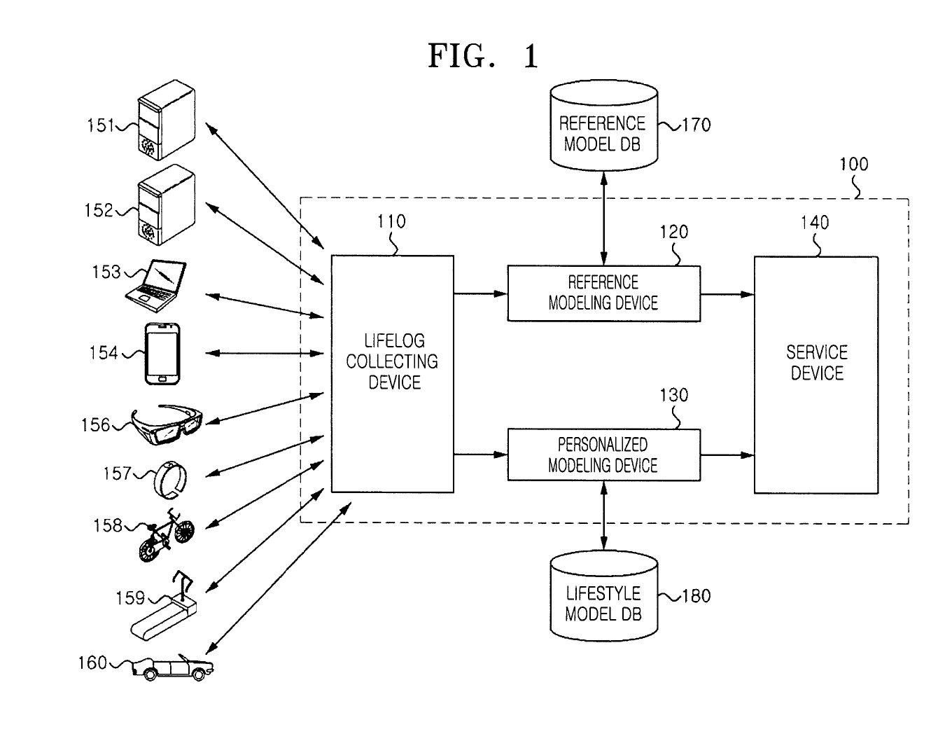

Hereinafter, autonomous lifestyle care system and method according to an exemplary embodiment of the present invention will be described in detail with reference to FIGS. 1 to 7.

FIG. 1 is a diagram illustrating a configuration of an autonomous lifestyle care system according to an exemplary embodiment of the present invention.

Referring to FIG. 1, an autonomous lifestyle care system 100 may include a lifelog collecting device 110, a reference modeling device 120, a personalized modeling device 130, and a service device 140.

The lifelog collecting device 110 may collect the lifelog by communicating with a private data management server 151, a public data management server 152, a personal computer 153, a smart phone 154, smart glasses 155, a smart watch 157, a bicycle 158, a running machine 159, a vehicle 160, and the like.

In this case, the lifelog may include at least one of private data, public data, personal data, anonymous data, connected data, and sensor data.

Here, the private data may include a calendar, an address book, credit card details, medical records, shopping details, call records, text records, bank records, stock trading records, various financial transaction records, and the like.

The public data may include traffic information, weather information, various statistical data, and the like.

The personal data may include favorites, search records, social networking service (SNS) conversation records, download records, blog records, and the like.

The anonymous data may include topic information (trend of public opinion) issued in the SNS, news, real-time keyword ranking, and the like.

The connected data may include records connected with a home or a vehicle and the like and for example, include occupancy detection, RFID (individual identification and access records), digital door locks, smart applications (use information), home network use records, Internet use records (access point), a car navigation system (movement path, etc.), a black box (video and audio records), tachographs (driving time, driving patterns, etc.).

The sensor data may include data measured through a dedicated device, an environmental sensor, a smart device, medical equipment, personal exercise equipment, a personal activity measuring device, and the like.

Here, the dedicated device may include a calorie measuring device, a position measuring device, a thermometer, a stress measuring device, an oral bad breath measuring device, a breathalyzer, distance/speed, GPS-based position measuring device, an apnea measuring device, a snoring measuring device, and the like.

The environment sensor may include a temperature sensor, a humidity sensor, a luminance sensor, CCTVs (streets, public transports, buildings, etc.), a carbon dioxide measuring sensor, an ozone measuring sensor, a carbon monoxide measuring sensor, a dust measuring sensor, a UV measuring sensor, and the like.

The smart device includes a smart phone, a head-mounted display (Google Glass, etc.), and a smart watch (Apple iWatch, etc.), and may acquire data such application payment details, often used applications, application usage details, GPS (location), recorded videos, audios, photos, and favorite music, and the like.

The medical equipment may include an electronic balance, a body fat measuring device, a diabetes measuring device, a heart rate measuring device, a blood pressure measuring device, and the like, and the measured data may include sensor data.

The personal exercise equipment may include exercise equipment capable of measuring an exercising amount such as sensors attached with a running machine, a bicycle, and running shoes, and the exercising amount measured from the exercise equipment may include sensor data.

Meanwhile, the lifelog collecting device 110 may be constituted by a separate device, but may be included in the reference modeling device 120 or the personalized modeling device 130.

The reference modeling device 120 receives the lifelog collected from the lifelog collecting device 110 and generates a reference model by using the collected lifelog.

In this case, the reference modeling device 120 may extract behavior sequences in the collected lifelog, analyze similarity between the extracted behavior sequences, and align the behavior sequences by using a sequence alignment method to generate the reference model. A more detailed description of the reference modeling device 120 will be described below with reference to FIG. 2.

The personalized modeling device 130 receives the lifelog collected from the lifelog collecting device 110, analyzes an individual tendency by using the collected lifelog, and generates a personalized lifestyle model for each tendency.

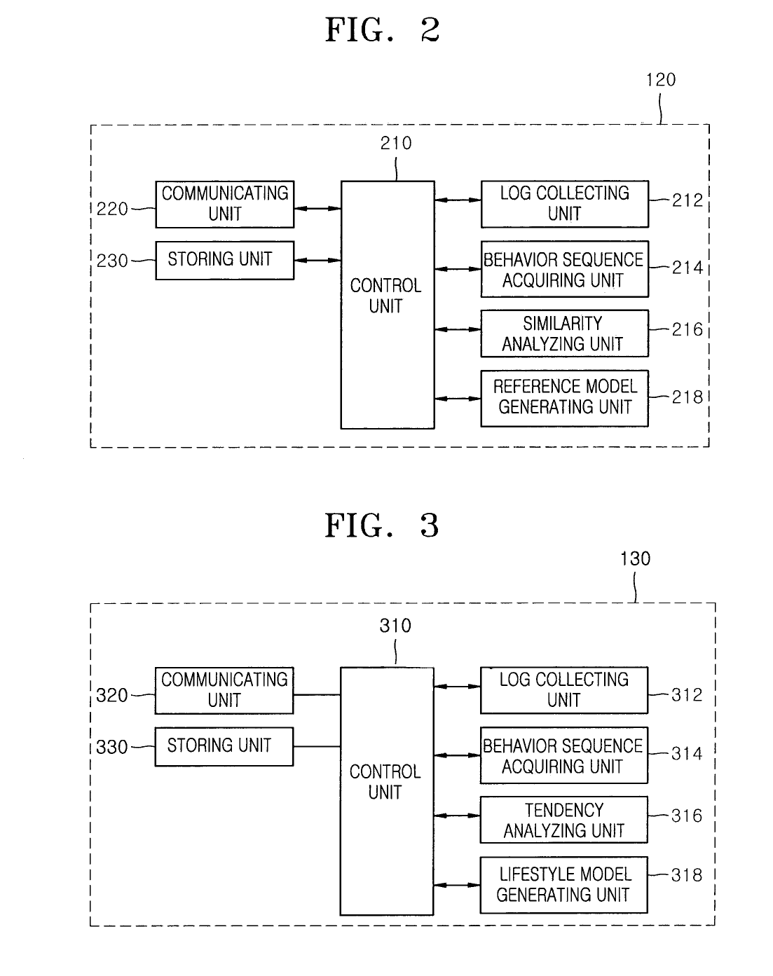

The personalized modeling device 130 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. A more detailed description of the personalized modeling device 130 will be described below with reference to FIG. 3.

The reference model generated in the reference modeling device 120 in the reference modeling device 120 and the personalized lifestyle model generated in the personalized modeling device 130 tend to be more accurate as the lifelogs are more and more accumulated. Accordingly, the reference model and the personalized lifestyle model automatically reflect the behavior sequences that may vary according to the age as time passes to be evolved over time.

Meanwhile, the reference model generated in the reference modeling device 120 in the reference modeling device 120 and the personalized lifestyle model generated in the personalized modeling device 130 may be united for the service to be provided to the service device 140.

The service device 140 estimates a possible user's behavior based on current information of the user which is collected by using the reference model received from the reference modeling device 120 and the personalized lifestyle model received from the personalized modeling device 130 and verifies whether the estimated user's behavior has a bad effect on the user's health.

As the verified result, when the estimated user's behavior has the bad effect on the user's health, the service device 140 may induce the user to avoid the estimated user's behavior. In this case, the service device 140 may use a direct method and an indirect method as the method of avoiding the estimated user's behavior.

The direct method is a method in which the user directly recognizes and avoids the possible behavior by transmitting the possible user's behavior to the user.

The indirect method as an unobtrusive method is a method of avoiding the user's behavior from occurring in advance by indicating any behavior to the user. Accordingly, in the indirect method, the user may not recognize the possible behavior.

For example, when verifying the personalized lifestyle model of any user, in the case of having a behavior sequence in which the user overeats meat in a meat restaurant on the way home when the user feels bad, if the user's current state is in a bad state, the user is on the way home from work, and the weight of the current user is obese, the user may be induced to avoid the behavior of overeating the meat by recommending a different path without the meat restaurant.

Further, in the case of additionally having a behavior sequence in which the user feels good when the user walks on the flower way, the user may be induced to change the user's feeling by providing the work-off path via the flower way.

FIG. 2 is a diagram illustrating a configuration of a reference modeling device modeling a generalized lifestyle according to the exemplary embodiment of the present invention.

Referring to FIG. 2, the reference modeling device 120 may include a control unit 210, a log collecting unit 212, a behavior sequence acquiring unit 214, a similarity analyzing unit 216, a reference model generating unit 218, a communicating unit 220, and a storing unit 230.

The communicating unit 220 transmits and receives data in wired manner or wirelessly as a communication interface device including a receiver and a transmitter. The communicating unit 220 may communicate with the lifelog collecting device 110, the service device 140, and the reference model DB 170 and directly communicates with a device of providing the lifelog to receive the lifelog.

The storing unit 230 may store an operating system for controlling the overall operation of the reference modeling device 120, application programs, and the like and further store the collected lifelog and the generated reference model according to the present invention. In this case, the storing unit 230 may be a storage device including a flash memory, a hard disk drive, and the like.

The log collecting unit 212 may receive the lifelog or receive the lifelog collected in the lifelog collecting device 110 through the communicating unit 220.

The behavior sequence acquiring unit 214 extracts the behavior sequences in the collected lifelog.

In more detail, the behavior sequence acquiring unit 214 extracts the behavior sequence having at least one of a stimulation idea, a recognition, an emotion, a behaviors, and a result in the collected lifelog by using a data mining method. In this case, the behavior sequence having the stimulation idea, the recognition, the emotion, the behaviors, and the result may be expressed like examples of Table 1.

TABLE 1
Development of emotional process

| Stimulation | | | | |
|---|---|---|---|---|
| Idea | Recognition | Emotion | Behaviors | Result |
| Thtreat | Danger | Fear, terror | Running, or | Protection |
| | | | flying away | |
| Obstacle | Enemy | Anger, rage | Biting, | Destruction |
| | | | hitting | |
| Potential | Possess | Joy, ecstasy | Courting, | Reproduction |
| Mate | | | mating | |
| Loss of | Isolation | Sadness, | Crying for | Reintegration |
| valued | | greif | help | |
| person | | | | |
| Gruesome | Poison | Disgust, | Vomiting, | Rejection |
| object | | loathing | pushing | |
| | | | away | |
| Group | Friend | Acceptance, | Grooming, | Affiliation |
| member | | trust | sharing | |
| New | What's out | Anticipation | Examining, | Exploration |
| territory | there? | | mapping | |
| Sudden | What is it? | Surprise | Stopping, | Orientation |
| novel | | | alerting | |
| object | | | | |

The behavior sequence acquiring unit 214 may extract the behavior sequence in the collected lifelog, but may also receive the behavior sequence from a user or an expert (a psychologist, etc.).

The similarity analyzing unit 216 analyzes similarity between the behavior sequences acquired through the behavior sequence acquiring unit 214.

In more detail, the similarity analyzing unit 216 may evaluate the similarity between the extracted behavior sequences by using at least one of whether the behavior sequence occurs within a predetermined time and whether information included in the behavior sequence is the same.

The reference model generating unit 218 aligns the behavior sequences by using a sequence alignment method to generate the reference model.

In more detail, the reference model generating unit 218 connects behavior sequences having high similarity in a tree form by using the similarity of the extracted behavior sequences to generate an ontology type reference model.

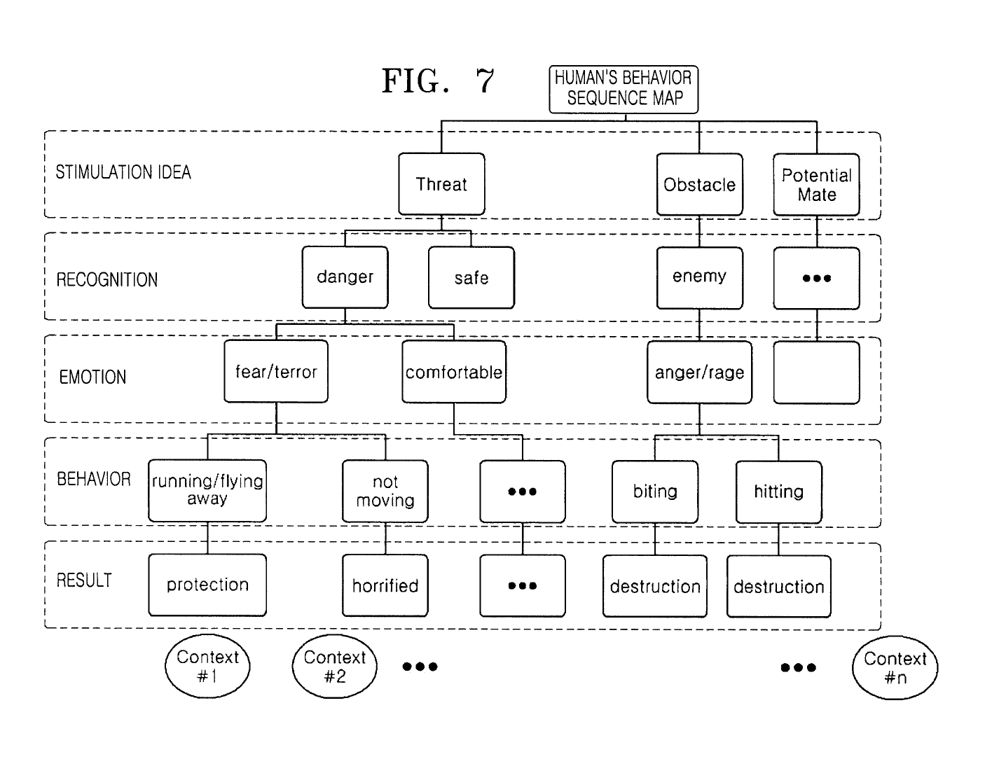

FIG. 7 is a diagram illustrating an example of the reference model generated according to the exemplary embodiment of the present invention.

FIG. 7 is an example of generating the behavior sequence in Table 1 as the reference model, and referring to FIG. 7, it can be seen that the reference model is constituted by a tree type ontology model.

A sequence alignment technique applied to the reference model generating unit 218 is a method which is frequently used in the similarity analysis of base sequences in a bioinformatics field and may be modified and applied to the prevent invention like the following Table 2.

TABLE 2

| | | Sequence Alignment |
|---|---|---|
| | | (Examples applied to |
| | Sequence Alignment | present invention) |
| Description | Method of analyzing | Method of analyzing |
| | similarity between base | similarity between |
| | sequences | behavior sequences |
| Comparison | Reference sequence | Bottom up build by using |
| | | algorithm in which path |
| | | extraction is possible like |
| | | decision tree |
| | read | Behavior occurring in |
| | | predetermined time |
| | | window |
| | Similar species/neighboring | Classification through |
| | species | Human profiling |
| | mismatch | Diversity of behavior |
| | | patterns according to |
| | | human/time/place |

The control unit 210 may control the overall operation of the reference modeling device 120. In addition, the control unit 210 may perform functions of the log collecting unit 212, the behavior sequence acquiring unit 214, the similarity analyzing unit 216, and the reference model generating unit 218. The control unit 210, the log collecting unit 212, the behavior sequence acquiring unit 214, the similarity analyzing unit 216, and the reference model generating unit 218 are separately illustrated to describe the respective functions. Accordingly, the control unit 210 may include at least one processor configured to perform the respective functions of the log collecting unit 212, the behavior sequence acquiring unit 214, the similarity analyzing unit 216, and the reference model generating unit 218. Further, the control unit 210 may include at least one processor configured to perform some of the respective functions of the log collecting unit 212, the behavior sequence acquiring unit 214, the similarity analyzing unit 216, and the reference model generating unit 218.

FIG. 3 is a diagram illustrating a configuration of a personalized modeling device modeling a personalized lifestyle according to the exemplary embodiment of the present invention.

Referring to FIG. 3, the personalized modeling device 130 may include a control unit 310, a log collecting unit 312, a behavior sequence acquiring unit 314, a tendency analyzing unit 316, a lifestyle model generating unit 318, a communicating unit 320, and a storing unit 330.

The communicating unit 320 transmits and receives data in wired manner or wirelessly as a communication interface device including a receiver and a transmitter. The communicating unit 320 may communicate with the lifelog collecting device 110, the service device 140, and the reference model DB 180 and may directly communicate with a device of providing the lifelog to receive the lifelog.

The storing unit 330 may store an operating system for controlling the overall operation of the personalized modeling device 130, application programs, and the like and further store the collected lifelog and the generated personalized lifestyle model according to the present invention. In this case, the storing unit 330 may be a storage device including a flash memory, a hard disk drive, and the like.

The log collecting unit 312 may receive the lifelog or receive the lifelog collected in the lifelog collecting device 110 through the communicating unit 320.

The behavior sequence acquiring unit 314 extracts individual behavior sequences in the collected lifelog. In more detail, the behavior sequence acquiring unit 314 retrieves the behavior pattern which is repeated more than a predetermined number of times for each individual in the collected lifelog by using the data mining method to extract the retrieved behavior pattern as the individual behavior sequence.

Meanwhile, the behavior sequence acquiring unit 314 may extract the behavior sequence in the collected lifelog, but may also receive the behavior sequence from a user or an expert (a psychologist, etc.).

The tendency analyzing unit 316 analyzes the individual tendency by using the collected lifelog. In more detail, the tendency analyzing unit 316 analyzes the individual tendency by determining interest, taste, and activity of each individual in activity information in the individual social network included in the collected lifelog. In this case, the activity information in the social network may include the number of access times to the social network, visited objects, the number of registered friends, the number of times of postings, the number of times of responses, analysis of the posting contexts, and the like.

The behavior sequence acquiring unit 314 and the tendency analyzing unit 316 may use Hadoop and MapReduce techniques as distributed computing techniques for analyzing a large lifelog. That is, the behavior sequence acquiring unit 314 and the tendency analyzing unit 316 stores and manages the individual behavior sequence through a Hadoop system and may distributed-process an analysis technique through MapReduce.

The lifestyle model generating unit 318 generates the personalized lifestyle model for each tendency by connecting the behavior sequences of the users having similar tendencies.

In more detail, the lifestyle model generating unit 318 analyzes similarity between the behavior sequences of the users having similar tendencies and may generate an ontology type personalized lifestyle model for each tendency by connecting the behavior sequences with high similarity in a tree form.

Meanwhile, the individual uses a specific heuristic for his determination or behavior, and verification of conformity of the individual lifestyle model is required by using the heuristic.

In the verification of conformity of the individual lifestyle model, an individual heuristic is determined by using the individual heuristic which is already devised by psychologists and physiologists. As a method for determining the individual heuristic, conformity of the individual heuristic and the individual lifestyle model may be verified by using question investigation and the like.

In addition, the individual lifestyle model may be readjusted by determining association between the individual lifestyle model and the heuristic of the user, determining conformity of the individual lifestyle model base on the heuristic (in association with the psychologist and the physiologist), and analyzing the heuristic.

However, a method of minimizing intervention of the user or the expert is preferably a method of verifying the conformity of the individual lifestyle model by estimating the individual heuristic through existing accumulated behavior sequences and the individual lifestyle model and retrieving the behavior sequences of the users having the same or similar heuristic to draw similar patterns between the individual lifestyle models.

The control unit 310 may control the overall operation of the personalized modeling device 130. In addition, the control unit 310 may perform functions of the log collecting unit 312, the behavior sequence acquiring unit 314, the tendency analyzing unit 316, and the lifestyle model generating unit 318. The control unit 310, the log collecting unit 312, the behavior sequence acquiring unit 314, the tendency analyzing unit 316, and the lifestyle model generating unit 318 are separately illustrated to describe the respective functions. Accordingly, the control unit 310 may include at least one processor configured to perform the respective functions of the log collecting unit 312, the behavior sequence acquiring unit 314, the tendency analyzing unit 316, and the lifestyle model generating unit 318. Further, the control unit 310 may include at least one processor configured to perform the respective functions of the log collecting unit 312, the behavior sequence acquiring unit 314, the tendency analyzing unit 316, and the lifestyle model generating unit 318.

Hereinafter, a method of managing the lifestyle in the autonomous lifestyle care system will be described below with reference to the accompanying drawings.

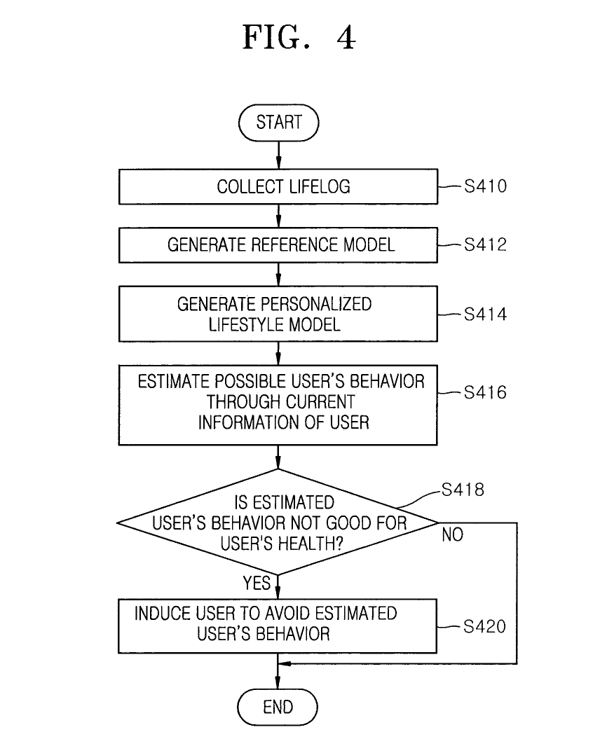

FIG. 4 is a flowchart illustrating a process of managing the lifestyle in the autonomous lifestyle care system according to the exemplary embodiment of the present invention.

Referring to FIG. 4, an autonomous lifestyle care system 100 collects the lifelog including at least one of private data, public data, personal data, anonymous data, connected data, and sensor data (S410).

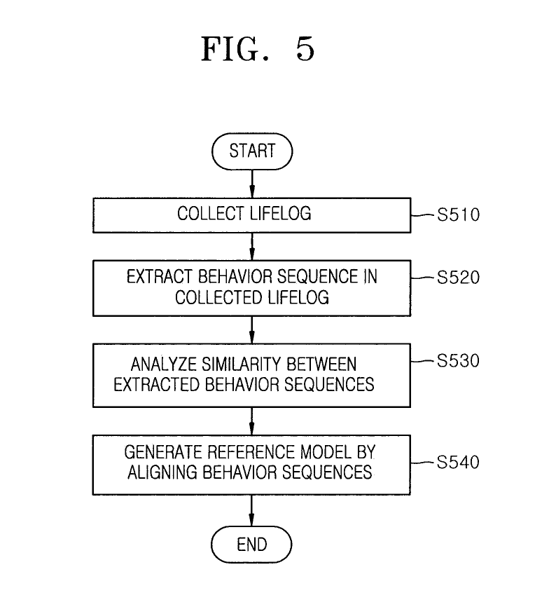

In addition, the autonomous lifestyle care system 100 generates the reference model by using the collected lifelog (S 412 ). In this case, the autonomous lifestyle care system 100 may extract behavior sequences in the collected lifelog, analyze similarity between the extracted behavior sequences, and align the behavior sequences by using a sequence alignment method to generate the reference model. The generating of the reference model will be described below in more detail with reference to FIG. 5.

In addition, the autonomous lifestyle care system 100 analyzes an individual tendency by using the collected lifelog and generates a personalized lifestyle model for each tendency (S414).

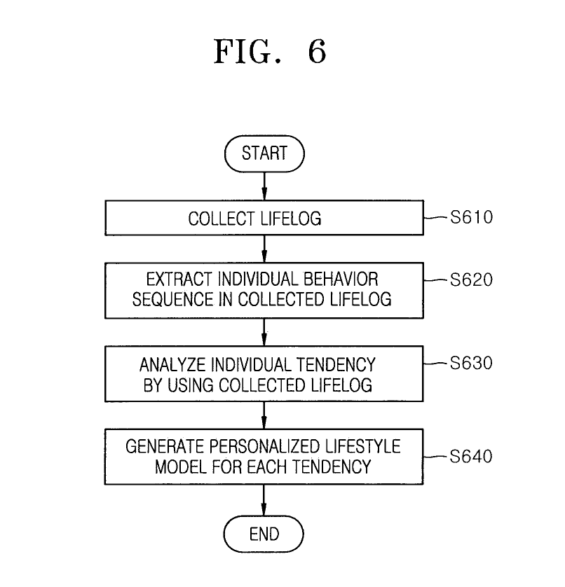

In this case, the autonomous lifestyle care system 100 may extract a behavior pattern which is repeated more than a predetermined number of times for each individual by using a data mining method in the collected lifelog as the individual behavior sequence, analyzes the individual tendency by analyzing activity information in an individual social network included in the collected lifelog, and generate the personalized lifestyle model for each tendency by connecting behavior sequences of users having similar tendencies. The generating of the personalized lifestyle model will be described below in more detail with reference to FIG. 6.

In addition, the autonomous lifestyle care system 100 estimates a possible user's behavior by reflecting user's current information which is collected in the reference model and the lifestyle model (S416).

In addition, the autonomous lifestyle care system 100 verifies whether the estimated user's behavior has a bad effect on the user's health (S418).

As verified in step S418, when the estimated user's behavior has the bad effect on the user's health, the autonomous lifestyle care system 100 induces the user to avoid the estimated user's behavior (S420).

In this case, the autonomous lifestyle care system 100 may transmit the possible user's behavior to the user in order to induce the user to avoid the estimated user's behavior or prevent the user's behavior from occurring by indicating any behavior to the user.

FIG. 5 is a flowchart illustrating a process of generating a reference model in the reference modeling device according to the exemplary embodiment of the present invention.

Referring to FIG. 5, the reference modeling device 120 collects the lifelog including at least one of private data, public data, personal data, anonymous data, connected data, and sensor data (S510).

In addition, the reference modeling device 120 extracts the behavior sequence in the collected lifelog (S520). In this case, the reference modeling device 120 may extract the behavior sequence having at least one of stimulation idea, recognition, emotion, behavior, and result in the collected lifelog by using a data mining method.

In addition, the reference modeling device 120 analyzes similarity between the extracted behavior sequences (S530). In this case, the reference modeling device 120 may evaluate and analyze the similarity between the extracted behavior sequences by using at least one of whether the behavior sequence occurs within a predetermined time and whether information included in the behavior sequence is the same.

In addition, the reference model generating unit 120 aligns the behavior sequences by using a sequence alignment method to generate the reference model (S540). In this case, the reference model generating unit 120 connects behavior sequences having high similarity in a tree form by using the similarity of the extracted behavior sequences to generate an ontology type reference model.

FIG. 6 is a flowchart illustrating a process of generating a personalized lifestyle model in the personalized modeling device according to the exemplary embodiment of the present invention.

Referring to FIG. 6, the personalized modeling device 130 collects the lifelog including at least one of private data, public data, personal data, anonymous data, connected data, and sensor data (S610).

In addition, the personalized modeling device 130 extracts the individual behavior sequence in the collected lifelog (S620). In this case, the personalized modeling device 130 may extract the behavior pattern which is repeated more than a predetermined number of times as the individual behavior sequence for each individual in the collected lifelog by using the data mining method.

In addition, the personalized modeling device 130 extracts the individual tendency by using the collected lifelog (S630). In this case, the personalized modeling device 130 may analyze the individual tendency by analyzing activity information in the individual social network included in the collected lifelog.

In addition, the personalized modeling device 130 generates the personalized lifestyle model for each tendency by connecting the behavior sequences of the users having similar tendencies (S640). In this case, the personalized modeling device 130 analyzes similarity between the behavior sequences of the users having similar tendencies and may generate an ontology type personalized lifestyle model for each tendency by connecting the behavior sequences with high similarity in a tree form.

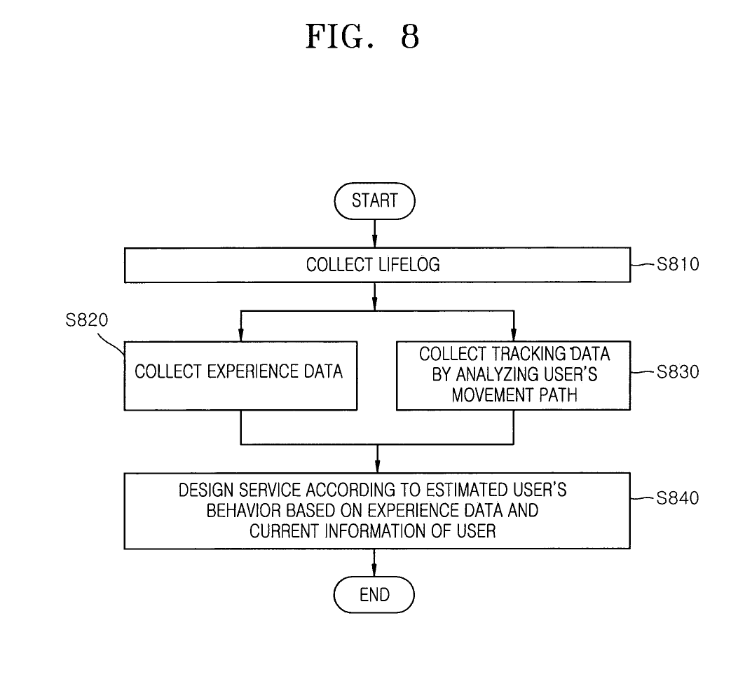

FIG. 8 is a flowchart illustrating a method for designing a lifestyle service according to another exemplary embodiment of the present invention.

In the method for designing a lifestyle service, a lifelog including at least one of private data, public data, personal data, anonymous data, connected data, and sensor data is collected (S810), and an individual tendency is analyzed by using the collected lifelog and personalized experience data for each tendency is collected for each individual (S820). In this case, in addition to step S820, tracking data is collected by analyzing a movement path of the user and the movement path of the user may be estimated from the collected tracking data (S830).

Thereafter, a possible user's behavior is estimated based on the experience data and current information of the user and a service is designed according to the estimated user's behavior (S840). In this case, the user may be motivated to avoid the estimated user's behavior by using the collected experience data and domain characteristics (SNS, card payment, shopping payment, location information, and the like), and the service may also be designed to induce the motivated user to avoid the estimated behavior.

Further, a surrounding environment of the user is analyzed and the service may be designed to induce the user to a change in the user's behavior through virtual experience by using the surrounding environment of the user.

Further, the service may be designed by analyzing a user's feature and a preferred channel according to the user's feedback to provide the designed service to the user according to the analyzed preferred channel. For example, when the characteristic of the user is a person who is visually impaired, the designed service may be provided to the user by selecting the most favorite effect from various effects such as an auditory effect and a tactile effect other than a visual effect by analyzing a preferred channel which the user prefers.

As another example, according to a user's mental state, when the user's mental state is in a depressed state, effects such as music of making the depressed state to be happy or a voice of a loved person may also be added and transferred together by analyzing the most favorite effect of the depressed people.

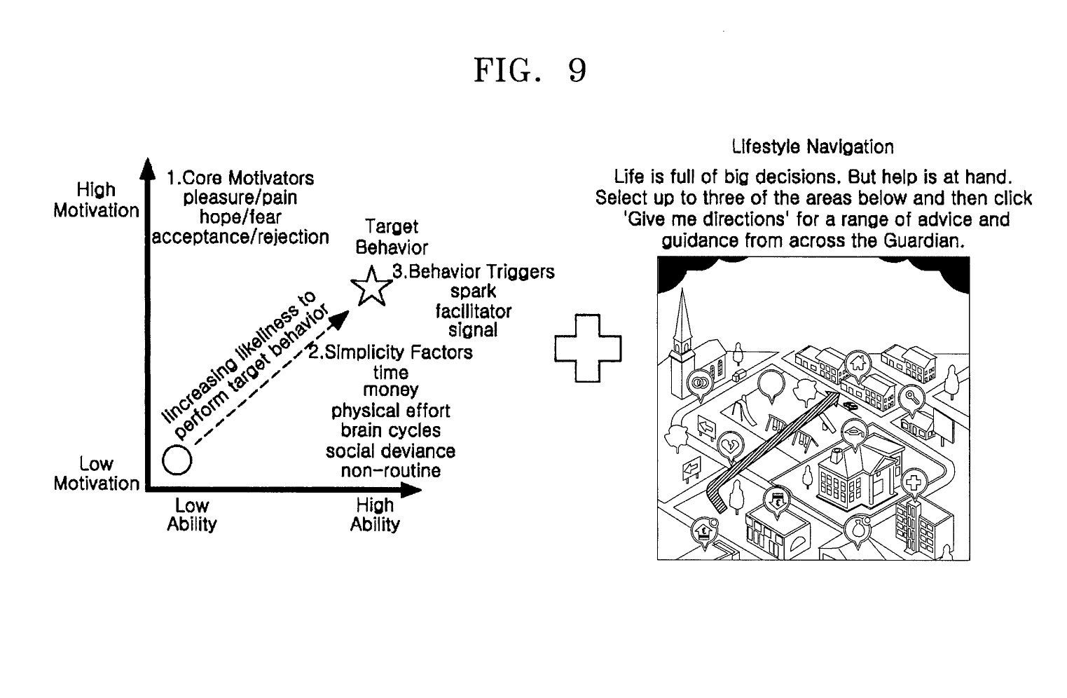

FIG. 9 is a diagram illustrating an example of a persuasion type design in a lifestyle service design according to another exemplary embodiment of the present invention.

A surrounding environment of the user is analyzed and the service may be designed to induce the user to a change in the user's behavior through virtual experience by using the surrounding environment of the user. The analysis of the surrounding environment of the user may be collected through information a public website, information on other open social networks, and the like.

For example, when it is determined that the user frequently purchases more burgers than a reference value in a burger shop on a moving line which always goes and thus a disorder in the health occurs, a new moving line is indicated to the user by providing information on an event in which the user may access a usually preferable hobby (movies, walking, exercising, reading, etc.) around the moving line instead of the moving line where the user purchases the burger in order to avoid the moving line where the user purchases the burger. As a result, the service may be designed in a direction in which the user is motivated to go the new moving line rather than the moving line where the burger restaurant is disposed. In this case, as the motivating method, a user's interest is caused by providing other related experience information or the user may be persuaded and induced to avoid the moving line where the burger restaurant is disposed through a virtual experience for the event and the like. New event information around the usual user's moving line may be obtained by analyzing the neighboring environment of the user as described above.

Further, according to the neighboring environment (weather) of the user, when the weather state in the position information of the user has a high discomfort index, in the case where the user's discomfort index is high or the psychological state is unstable by determining the user's psychological state, information on an ice cream shop located on the moving line where the user usually goes or a place where the user's psychological state is stable may be provided to the user.

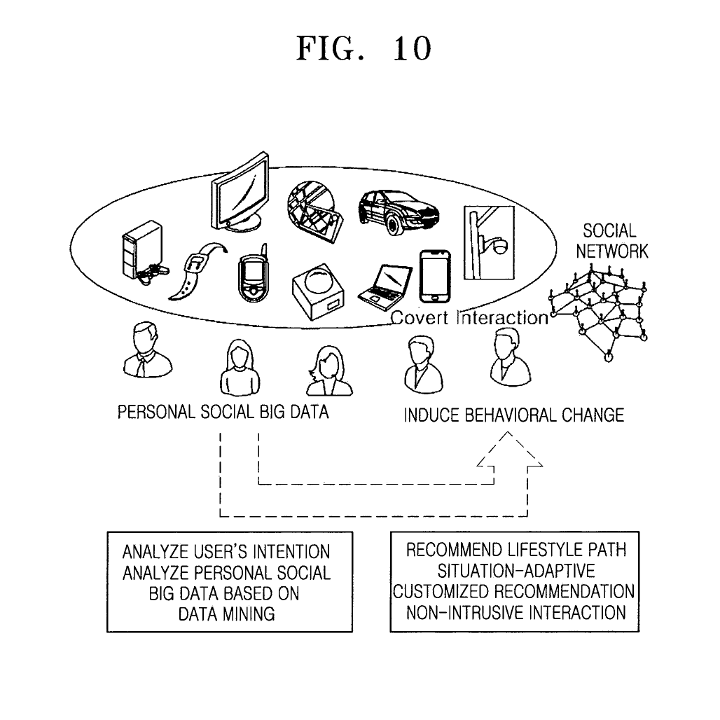

FIG. 10 is a diagram illustrating an example for determining an implicit motive and inducing a behavior in the lifestyle service design according to yet another exemplary embodiment of the present invention.

A possible user's behavior is estimated based on the experience data and current information of the user and a service is designed according to the estimated user's behavior (S840). In this case, the user may be motivated to avoid the estimated user's behavior by using the collected experience data and domain characteristics (SNS, card payment, shopping payment, location information, and the like), and the service may also be designed to induce the motivated user to avoid the estimated behavior.

For example, it is assumed that the user has a lifestyle requiring interference such as frequently eating fast food such as a hamburger even though the user recognizes the fact that there is a risk of obesity through health diagnostic information of the user. In this case, in order to analyze motivation and causes of frequently eating a specific fast food, user's social network information and big data information on a user's purchase pattern may be collected. Through the analysis of the big data, in the case of obtaining the conclusion that the user frequently eats the hamburger because the hamburger shop is disposed accidentally on the moving line which usually goes at a work-off time around an evening, not that the user particularly prefers a particular fast-food (ex. Hamburgers), the user is induced to change a usual moving line on the way home from work to improve the lifestyle. In other words, the service for avoiding the hamburger purchase of the user is designed by analyzing experience data in which the user passes ahead the hamburger shop which is located on the moving line passing more than a predetermined number of times and domain characteristics (hamburger payment details and use's position information) of the user' current information. In this case, in order to avoid the user's behavior of purchasing the hamburger, when the user has an intention of purchasing the hamburger by determining information on a usually interest field of the user, the user is motivated by providing information on the usually interest field of the user to the user and a change in user's behavior may be induced by recommending the path of the lifestyle of the user.

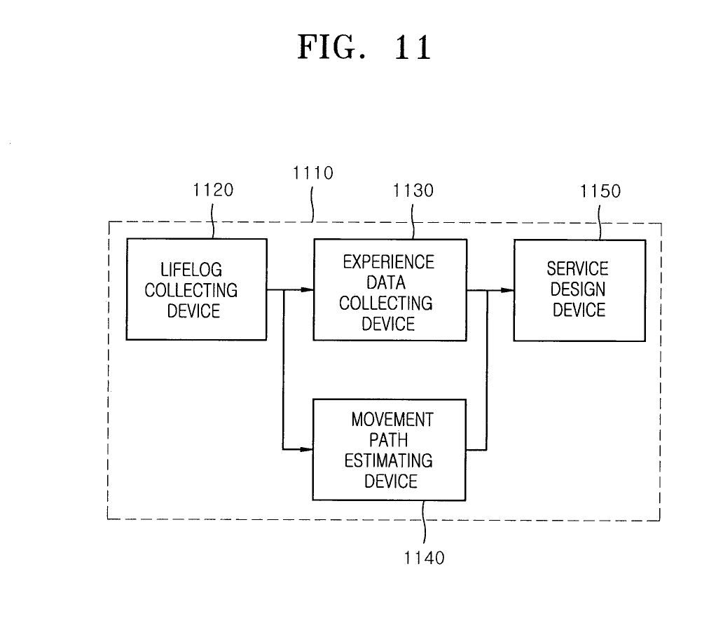

FIG. 11 is a diagram illustrating a configuration of a system for designing a lifestyle service according to still another exemplary embodiment of the present invention.

A system 1110 for designing a lifestyle service includes a lifelog collecting device 1120 collecting lifelogs; an experience data collecting device 1130 analyzing individual tendencies by using the collected lifelogs and collecting personalized experience data for each individual tendency; and a service design device 1150 estimating a possible user's behavior based on the experience data and current information of the user and designing a service according to the estimated user's behavior.

The lifelog collecting device 1120 may include at least one of private data, public data, personal data, anonymous data, connected data, and sensor data.

The experience data collecting device 1130 may include the system 1110 for designing the lifestyle service which collects analysis of individual activities by analyzing life patterns which are repeated more than a predetermined number of times in the collected lifelogs. In this case, in addition to the experience data collecting device 1130, a movement path estimating device 110 may collect tracking data by analyzing the movement path of the user and estimate the movement path of the user from the collected tracking data.

The service design device 1150 may motivate the user to avoid the estimated user's behavior by using the collected experience data and domain characteristics (SNS, card payment, shopping payment, location information, and the like) of the user's current information and design the service to induce the motivated user to avoid the estimated behavior.

Further, the service design device 1150 may analyze a surrounding environment of the user and design the service to induce the user to a change in the user's behavior through virtual experience by using the surrounding environment of the user.

Further, the service design device 1150 may design the service by analyzing a user's feature and a preferred channel according to the user's feedback to provide the designed service to the user according to the analyzed preferred channel.

The method for designing the lifestyle service according to the exemplary embodiment of the present invention may be implemented as a program command which may be executed by various computers to be recorded in a computer readable medium. The computer readable medium may include one or a combination of a program command, a data file, and a data structure. The program command recorded in the medium may be specially designed and configured for the present invention, or may be publicly known to and used by those skilled in the computer software field. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, an eMMC, specially formed to store and execute a program command. An example of the program command includes a high-level language code executable by a computer by using an interpreter, and the like, as well as a machine language code created by a compiler. The hardware device may be configured to be operated with one or more software modules in order to perform the operation of the present invention, and an opposite situation thereof is available.

The present invention has been described by the specified matters such as specific components and limited exemplary embodiments and drawings, which are provided to help the overall understanding of the present invention and the present invention is not limited to the exemplary embodiments, and those skilled in the art will appreciate that various modifications and changes can be made within the scope without departing from an essential characteristic of the present invention.

Therefore, the spirit of the present invention is defined by the appended claims rather than by the description preceding them, and the claims to be described below and it should be appreciated that all technical spirit which are evenly or equivalently modified are included in the claims of the present invention.

### INDUSTRIAL APPLICABILITY

The present invention relates to a technique of managing a lifestyle, and the present invention is directed to provide a system and a method for designing a lifestyle service which collects big data of personal lifelogs, collects analysis of personal activities through the collected lifelogs, and estimates possible user's behavior based on the collected analysis of personal activities to induce the user's behavior in a preferable direction which may improve quality of life according to the estimated user's behavior to manage the user's health.

1. A system for designing a lifestyle service comprising:
a lifelog collecting device configured to collect lifelogs;
an experience data collecting device configured to analyze individual tendencies by using the collected lifelogs and collect personalized experience data for each individual tendency; and
a service design device configured to estimate a possible user's behavior based on the experience data and current information of the user and design a service according to the estimated user's behavior.

2. The system for designing the lifestyle service of claim 1, wherein the lifelogs includes at least one of private data, public data, personal data, anonymous data, connected data, and sensor data.

3. The system for designing the lifestyle service of claim 1, wherein the experience data collecting device collects analysis of individual activities by analyzing life patterns which are repeated more than a predetermined number of times in the collected lifelogs.

4. The system for designing the lifestyle service of claim 1, further comprising:
a movement path estimating device configured to collecting tracking data by analyzing a movement path of the user and estimating the movement path of the user from the collected tracking data.

5. The system for designing the lifestyle service of claim 1, wherein the service design device motivates the user to avoid the estimated user's behavior by using the collected experience data and domain characteristics (SNS, card payment, shopping payment, location information, and the like) and designs the service to induce the motivated user to avoid the estimated behavior.

6. The system for designing the lifestyle service of claim 1, wherein the service design device analyzes a surrounding environment of the user and designs the service to induce the user to a change in the user's behavior through virtual experience by using the surrounding environment of the user.

7. The system for designing the lifestyle service of claim 1, wherein the service design device designs the service by analyzing a user's feature and a preferred channel according to the user's feedback to provide the designed service to the user according to the analyzed preferred channel.

8. A method for designing a lifestyle service comprising:
collecting lifelogs;
analyzing individual tendencies by using the collected lifelogs and collecting personalized experience data for each individual tendency; and
estimating a possible user's behavior based on the experience data and current information of the user and designing a service according to the estimated user's behavior.

9. The method for designing the lifestyle service of claim 8, wherein the lifelogs includes at least one of private data, public data, personal data, anonymous data, connected data, and sensor data.

10. The method for designing the lifestyle service of claim 8, wherein in the collecting of the experience data, analysis of individual activities may be collected by analyzing life patterns which are repeated more than a predetermined number of times in the collected lifelogs.

11. The method for designing the lifestyle service of claim 8, further comprising:
collecting tracking data by analyzing a movement path of the user and estimating the movement path of the user from the collected tracking data.

12. The method for designing the lifestyle service of claim 8, wherein in the designing of the service, the user is motivated to avoid the estimated user's behavior by using the collected experience data and domain characteristics (SNS, card payment, shopping payment, location information, and the like) and the service is designed to induce the motivated user to avoid the estimated behavior.

13. The method for designing the lifestyle service of claim 8, wherein in the designing of the service, a surrounding environment of the user is analyzed and the service is designed to induce the user to a change in the user's behavior through virtual experience by using the surrounding environment of the user.

14. The method for designing the lifestyle service of claim 8, wherein in the designing of the service, the service is designed by analyzing a user's feature and a preferred channel according to the user's feedback to provide the designed service to the user according to the analyzed preferred channel.

15. (canceled)
